(19) United States
(12) Patent Application Publication
(10) Pub. No.: US 2009/0278932 A1
(43) Pub. Date: Nov. 12, 2009

(54) System and Method of Optical Sensing in an Aerial Vehicle

(76) Inventor: Steven Yi, Vienna, VA (US)

Correspondence Address: STEVEN L. NICHOLS;RADER, FISHMAN & GRAUER PLLC, 10653 S. RIVER FRONT PARKWAY, SUITE 150, SOUTH JORDAN, UT, 84095, US

(21) Appl. No.: 12/117,898

(22) Filed: May 9, 2008

(51) Int. Cl. H04N 5/232; H04N 5/225; H04N 7/18

(52) U.S. Cl. 348/147; 348/361; 348/211.9; 348/E05.024; 348/E05.042; 348/E07.085

(57) ABSTRACT

A system for optical sensing in an aerial vehicle has at least one camera, an electronically-controlled mirror configured to dynamically direct light from a region of interest into the at least one camera, and at least one electronically-controlled adaptive polymer lens disposed between the mirror and the camera.

### BACKGROUND

Unmanned Aerial Vehicles (UAVs) are unpiloted aircraft that are generally capable of controlled, sustained level flight. Typically UAVs are controlled by autonomous navigation systems, operators on the ground, or some combination thereof. UAVs may be used for a variety of applications, for example, reconnaissance.

In some aerial applications, the use of UAVs is considerably more economic and less risky to human and other resources than the alternative of deploying a piloted aircraft. Often UAVs are significantly smaller than piloted aircraft, and therefore can be more difficult to detect and/or disable in hostile environments.

As indicated, one of the more common uses for UAVs presently is that of ground surveillance and reconnaissance. UAVs used for this type of task are generally equipped with an imaging system. Such an imaging system may include, for example, lenses, one or more cameras, and mirrors to reflect a ground image through the lenses to the camera(s).

UAVs are powered by an engine (e.g. a jet engine or an internal combustion engine). As with most aircraft, the weight and size of payload components in a UAV may appreciably affect the economy and power requirements of the UAV. Unfortunately, many of the optical components used in current reconnaissance UAVs, such as powered gimbals for mirror control and powered axially translatable lenses for zoom control, are weighty and consume a lot of power. These components are, therefore, limiting to the range and operating costs of the UAVs.

### BRIEF DESCRIPTION OF THE DRAWINGS

The accompanying drawings illustrate various embodiments of the present method and system and are a part of the specification. The illustrated embodiments are merely examples of the present system and method and do not limit the scope thereof.

FIG. 1 is a block diagram of an illustrative system for optical sensing according to one embodiment of the principles described herein.

FIG. 2 is an illustration showing an illustrative aerial vehicle in communication with a ground control unit according to one embodiment of the principles described herein.

FIG. 3A is a cross-sectional view of an illustrative adaptive polymer lens in a convex position according to one embodiment of the principles described herein.

FIG. 3B is a cross-sectional view of an illustrative adaptive polymer lens in a concave position according to one embodiment of the principles described herein.

FIGS. 4A and 4B are side views of an illustrative array of lenses in a system of optical sensing according to one embodiment of the principles described herein.

FIG. 5 is a side view of an illustrative system of optical sensing according to one embodiment of the principles described herein.

FIGS. 6A-6C are simple illustrations of an illustrative aerial vehicle capturing optical images of the ground below, according to one embodiment of the principles described herein.

FIG. 7 is a flowchart diagram of an illustrative method of optical sensing in an aerial vehicle, according to one embodiment of the principles described herein.

Throughout the drawings, identical reference numbers designate similar, but not necessarily identical, elements.

### DETAILED DESCRIPTION

As described above, unmanned aerial vehicles or UAVs are often equipped with optical equipment to capture images for surveillance or reconnaissance. Unfortunately, the weight of some of these components (e.g. powered gimbals and axially translatable lenses) may affect the power and range of the UAV. Additionally, some powered components may consume a lot of electrical power, and thus reduce the life of batteries used to provide electricity to other components in the UAV, for example guidance, propulsion or communications equipment. It may be desirable, therefore, to provide an optical system for UAVs having reduced weight and power consumption.

To accomplish these and other goals, the present specification discloses systems and methods of optical sensing in an aerial vehicle, in which light from a region of interest is reflected off of an electronically-controlled mirror through at least one electronically-controlled adaptive polymer lens into one or more cameras in the aerial vehicle. The electronically-controlled mirror may be selectively positioned using a piezoelectric device or an acoustic coil in place of electrically driven gimbals, and optical zoom may be controlled by selectively altering the concavity in the polymer lens(es) instead of by powered axially translatable lenses.

As used in the present specification and in the appended claims, the term “electronically-controlled polymer lens” refers broadly to a polymer optical lens having a degree of concavity and/or convexity that may be selectively altered by an electrical signal.

As used in the present specification and in the appended claims, the term “visible light” refers broadly to radiated energy having a wavelength approximately between 0.4 μm and 0.75 μm.

As used in the present specification and in the appended claims, the term “near-infrared” (NIR) light refers broadly to radiated energy having a wavelength approximately between 0.75 μm and 1.4 μm. Similarly, an NIR camera is a camera configured to detect and record at least NIR light.

As used in the present specification and in the appended claims, the term “short-wave infrared” (SWIR) refers broadly to radiated energy having a wavelength approximately between 1.4 μm and 3.0 μm. An SWIR camera is a camera configured to detect and record at least SWIR light.

As used in the present specification and in the appended claims, many of the functional units described in the present specification have been labeled as “modules” in order to more particularly emphasize their implementation independence. For example, modules may be implemented in software for execution by various types of processors. An identified module or module of executable code may, for instance, include one or more physical or logical blocks of computer instructions that may, for instance, be organized as an object, procedure, or function. Nevertheless, the executables of an identified module need not be physically located together, but may include disparate instructions stored in different locations which, when joined logically together, collectively form the module and achieve the stated purpose for the module. For example, a module of executable code could be a single instruction, or many instructions, and may even be distributed over several different code segments, among different programs, and across several memory devices. In other examples, modules may be implemented entirely in hardware, or in a combination of hardware and software.

In the following description, for purposes of explanation, numerous specific details are set forth in order to provide a thorough understanding of the present system and method for a three-dimensional ear biometrics technique. It will be apparent, however, to one skilled in the art that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

### Illustrative Systems

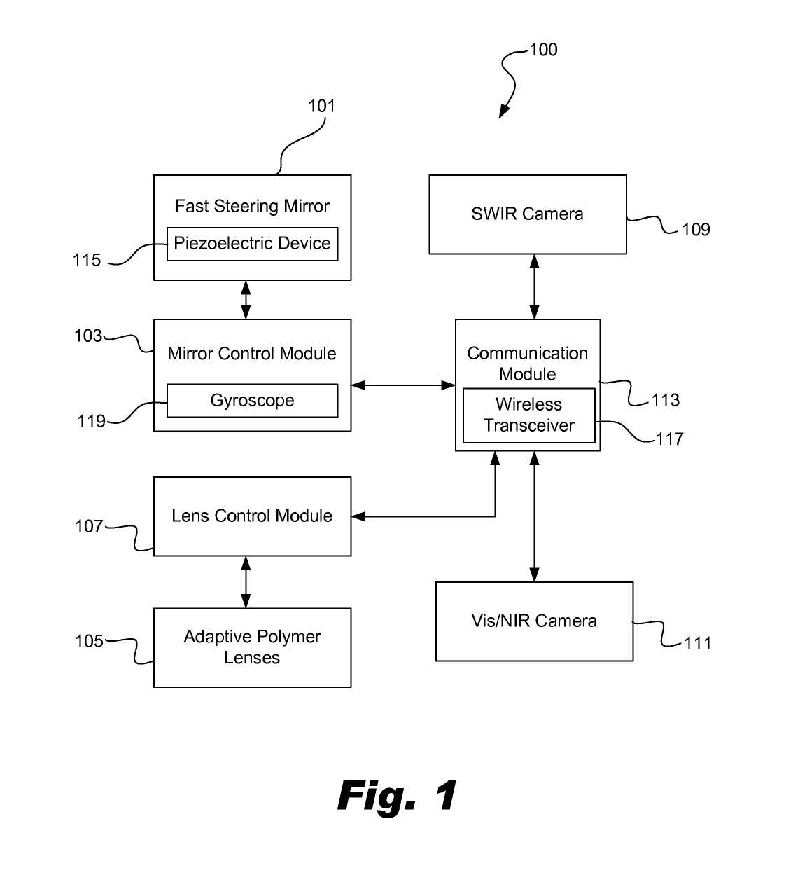

Referring now to FIG. 1, a block diagram of an illustrative system (100) for optical sensing in an aerial vehicle is shown. The illustrative system (100) may include a fast steering mirror (101), a mirror control module (103), adaptive polymer lenses (105), a lens control module (107), an SWIR camera (109), a Visible/NIR camera (111), and a communication module (113).

The fast steering mirror (101) may be configured to receive a ground image through a window or other aperture in the aerial vehicle and reflect the ground image through the adaptive polymer lenses (105) into one or both of the cameras (109, 111). The fast steering mirror (101) may be characterized by low noise, high pointing accuracy, and high acceleration/step speeds.

In the present example, the fast steering mirror (101) includes a piezoelectric device (115) configured to drive the mirror (101) to a selected position. The piezoelectric device (115) may be used for drift and vibration correction in at least two axes. In other embodiments, the fast steering mirror (101) may be driven by an acoustic coil (not shown). Piezoelectric devices (115) may offer ultrafast operation, but have smaller steering angles when used to drive fast steering mirrors (101). In contrast, acoustic coils may drive fast steering mirrors (101) at lower speeds than piezoelectric devices (115), while providing a larger steering angle.

Both piezoelectric based and acoustic coil based fast steering mirrors (101) may be significantly lighter and more energy efficient than mirrors that are steered with powered gimbals. In certain embodiments, piezoelectric based and acoustic coil based fast steering mirrors (101) may be steered more accurately than their powered gimbal counterparts.

The mirror control module (103) may be used to provide an electronic drive signal to the fast steering mirror (101). The drive signal may be received into the piezoelectric device (115), thereby inducing mechanical motion in the piezoelectric device (115), and by extension, in the fast steering mirror (101). By selectively controlling the drive signal provided to the fast steering mirror (101), mechanical motion by the fast steering mirror (101) may be controlled, thus enabling the orientation and/or positioning of the fast steering mirror (101) to be controlled.

Movement by the fast steering mirror (101) may alter and may be used to control the field of view of the ground image that is received by the cameras (109, 111). Therefore, the ground image captured by the cameras (109, 111) may be selectively panned along two or more axes using the mirror control module (103).

This ability to pan the camera image may be used when a dynamic image adjustment is desired by a user on the ground or mandated by an algorithm or predetermined set of instructions in the mirror control module (103). For some cases in which a user on the ground desires a dynamic adjustment of the camera image, the user may operate equipment on the ground that communicates with the communication module (113). The mirror control module (103) may be communicatively coupled to the communication module (113). Therefore, an image positioning instruction issued by the user on the ground may be received by the communication module (113) in a wireless transceiver (117) and forwarded to the mirror control module (103). The mirror control module (103) may then carry out the command by selectively altering the drive signal to the fast steering mirror (101).

The communication module (113) may be configured to communicate with equipment on the ground using any suitable protocol, including standardized protocols and custom protocols, as may best fit a particular application. Furthermore, the communication module (113) may be configured to stream camera images and other data to equipment on the ground. The communication module (113) may also be configured to encrypt data being transmitted to equipment on the ground and decrypt data being received from the equipment on the ground for security. Additionally or alternatively, the system (100) may include a logging module configured to store camera images and/or other data which may be downloaded to another system after the aerial vehicle has landed.

In addition to making user-defined and automatically programmed mirror adjustments, the mirror control module (103) may also be configured to make adjustments to the positioning of the fast steering mirror (101) to automatically compensate for acoustic vibrations, navigational changes in pitch, aerial turbulence, and the like. To detect these anomalies, the mirror control module (103) may include at least one gyroscope (119). In certain embodiments, at least two gyroscopes (119) may be used to detect movement along multiple axes by the aerial vehicle. Each gyroscope (119) may provide an electrical signal to control circuitry in the mirror control module (103) corresponding to axial movement detected by the gyroscope (119). Circuitry in the mirror control module (103) may then determine and induce a compensatory motion in the fast steering mirror (101) to mitigate the effects of the anomaly on the stability of the image reflected to the cameras (109, 111) by the fast steering mirror (101).

In certain embodiments, the gyroscopes (119) may be microelectromechanical systems (MEMS) gyroscopes. MEMS components may have a significantly reduced size and power consumption compared to conventional gyroscopes.

The adaptive polymer lenses (105) may be used to control focus and zoom in the ground image reflected to the cameras (109, 111). Traditional methods of zoom and focusing in aerial vehicles use electric motors to move lenses to different positions. These traditional systems are generally bulky, heavy, power-consuming, and operate at slower speeds. However, the use of active optics, such as the adaptive polymer lenses (105) in the system (100) may result in electronic zoom switching and a focusing solution that is smaller, lighter, faster, and consumes less power than traditional methods.

The adaptive polymer lenses (105) may have a concavity or convexity that is selectively altered according to an electrical signal applied to the adaptive polymer lenses (105), as will be explained in more detail below. By altering the concavity or convexity of the adaptive polymer lenses (105), the focus and/or magnification of the ground image reflected to the cameras (109, 111) may be focused.

The lens control module (107) may be configured to provide a driving electrical signal to the adaptive polymer lenses (105) to configure the adaptive polymer lenses (105) according to desired focus and magnification settings. These desired settings may be provided by an algorithm executed by the mirror control module (103), a stored set of parameters, and/or feedback from equipment on the ground received by the communication module (113). The communication module (113) may be communicatively coupled to the lens control module (107) to enable the transmission of remote commands to the lens control module (107).

In certain embodiments, the adaptive polymer lenses (105) may be used in conjunction with one or more fixed, passive lenses to provide the desired magnification and focus of the ground image, as may best suit a particular application of the principles described herein.

The SWIR camera (109) may be configured to detect optical energy in the ground image reflected by the fast steering mirror (101) having a wavelength approximately between 1.4 μm and 3.0 μm. This particular band of optical energy may be useful in detecting images under low light conditions. The Visible/NIR camera (111) may be configured to detect both visible and near infrared optical energy (i.e. having a wavelength approximately between 0.4 μm and 1.4 μm), which may be more useful in detecting images under daylight conditions. In certain embodiments, a dichroic beam splitter may be employed within the system (100) to manipulate the optical energy from the mirror (101) having a wavelength within the visible and near infrared spectra to the Visible/NIR camera (111) and optical energy having a wavelength within the shortwave infrared spectrum to the SWIR camera (109).

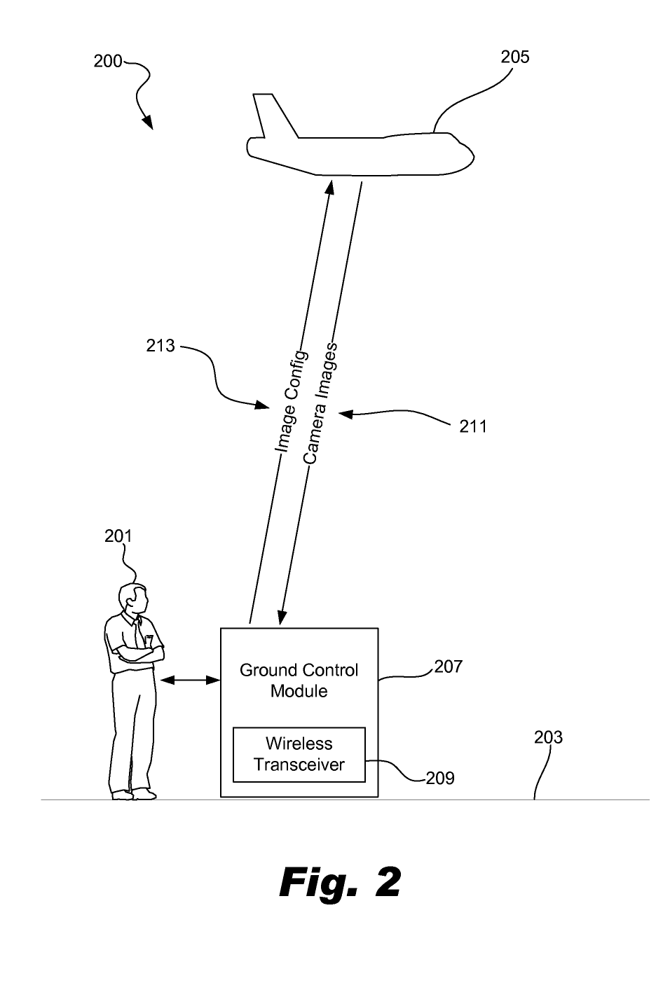

Referring now to FIG. 2, an illustrative system (200) is shown in which a user (201) on the ground (203) may communicate with an aerial vehicle (205) housing a system (100, FIG. 1) for optical sensing as described above.

The user (201) may be able to interface with the aerial vehicle (205) using a ground control module (207). The ground control module (207) may include a wireless transceiver (209) that is configured for bilateral communication with the wireless transceiver (117, FIG. 1) in the communication module (113, FIG. 1) housed in the aerial vehicle (205).

The ground control module (207) may include peripheral devices, such as a keyboard, monitor, touchscreen, pointer device, microphone, and/or speakers configured to provide camera images to, and receive input from, the user (201). Some or all of the input from the user (201) may be transmitted to the communication module (113, FIG. 1) housed in the aerial vehicle (205). The ground control module (207) may also display information for the user (201), received from the UAV (205). For example, the aerial vehicle (205) may be configured to transmit real-time images (211) captured by one or more cameras (109, 111, FIG. 1) to the ground control module (207). The images may then be displayed on a screen of the ground control module (207) to the user (201). Similarly, the user (201) may be able to provide image configuration settings (213) to the communication module (113, FIG. 1) of the aerial vehicle (205), which may then be used to adjust magnification, focus, or pan settings as described above.

In certain embodiments, the ground control module (207) may also receive from and transmit data to the aerial vehicle (205) that is not directly related to the system for optical sensing (100, FIG. 1), including, but not limited to, navigational data, speed data, sensor data, targeting data, weapons systems data, auxiliary systems data, fuel levels, system diagnostic data, payload data, and the like.

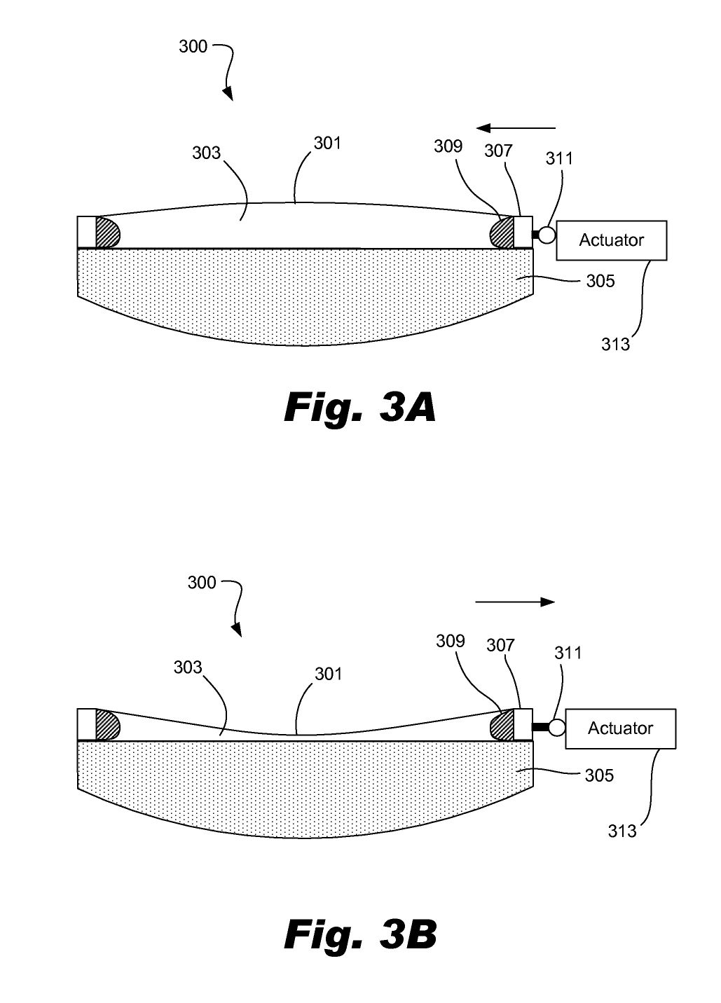

Referring now to FIGS. 3A-3B, an illustrative adaptive polymer lens (300) is shown in different configurations. While the present example discloses one type of adaptive polymer lens (300), it will be understood that any suitable type of adaptive polymer lens in any suitable configuration may be used as may best suit a particular application. More details regarding adaptive polymer lenses (300) may be found in U.S. Pat. No. 7,142,369 to Wu et al, the entire disclosure of which is incorporated herein by reference.

The adaptive polymer lens (300) may include a clear distensible membrane (301). A clear liquid (303) may be contained by the clear distensible membrane (301) on a first side and a clear substrate (305) on a second, opposite side. A rigid periphery seal (307) may be coupled to the distensible membrane (301) and the clear substrate (305), thus preventing the liquid (303) from leaking.

The periphery seal (307) may be configured to house a plunger body (309) that may be selectively moved in and out of the seal (307) to increase and decrease the volume defined by the distensible membrane (301), the clear substrate (305), and the periphery seal (307). Changes in this volume may cause the membrane (301) to flex or retract, thus altering the concavity or convexity of the adaptive polymer lens (300). Movement by the plunger body (309) may be externally controlled using a lever (311). As shown in FIG. 3A, the lens (300) can be made more concave by depressing the lever (311) in a first direction (illustrated by the arrow). As shown in FIG. 3B, the lens (300) can be made more convex by retracting the lever (311) in a second, opposite direction (illustrated by the arrow). A neutral lever position may exist in which the membrane (301) is approximately flat. The clear substrate (305) may have a passive concavity or convexity on one side to provide a bias for optical beams entering or leaving the adaptive polymer lens (300).

An actuator (313) may be used to selectively depress and retract the lever (311) according to a drive signal received from the lens control module (107, FIG. 1). In certain embodiments, the actuator may include a MEMS motor or a piezoelectric device, both of which typically consume dramatically reduced amounts of energy and are generally light and inexpensive.

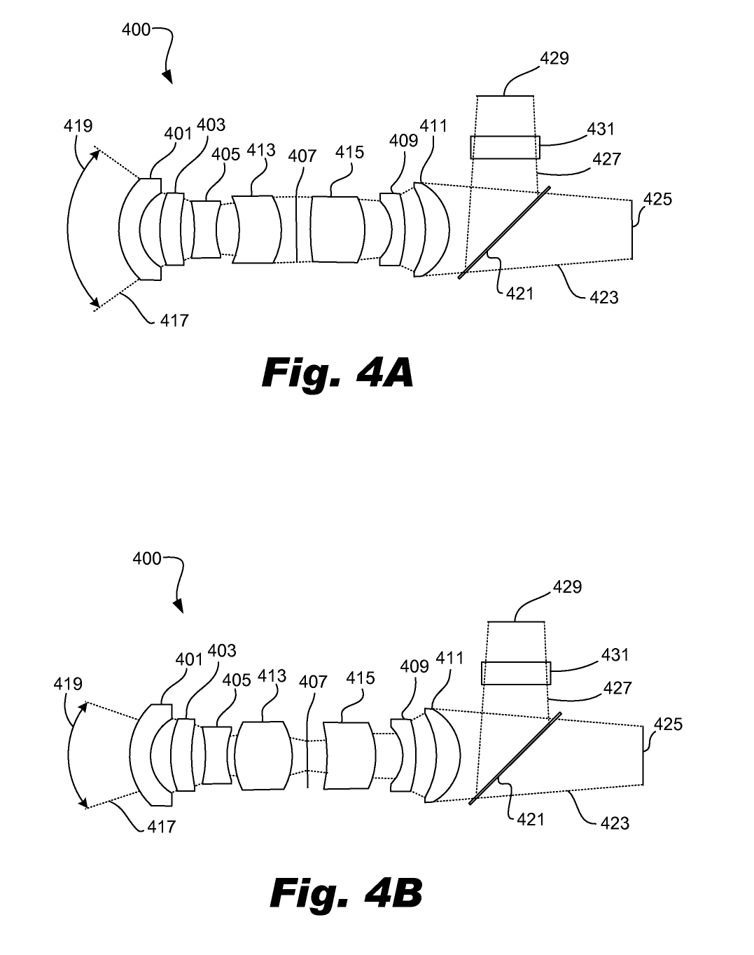

Referring now to FIGS. 4A-4B, a side view is shown of an illustrative lens array (400) in a system of optical sensing in an aerial vehicle. The array (400) may include a plurality of passsive lenses (401, 403, 405, 407, 409, 411) and two adaptive polymer lenses (413, 415). Optical energy (417) from a field of view (419) may be received into the array (400) and transmitted through the lenses (401, 403, 405, 407, 409, 411, 413, 415) to a dichroic beam splitter (421) configured to transmit optical energy of the visible-NIR wavelengths (423) to optical sensors (425) of a visible-NIR camera (111, FIG. 1) and reflect optical energy of the SWIR wavelengths (427) to optical sensors (429) of an SWIR camera (109, FIG. 1). A compensation lens (431) may be disposed between the dichroic beam splitter (421) and the optical sensors (429) of the SWIR camera.

By altering the concavity or convexity of the adaptive polymer lenses (413, 415), the field of view (419) accepted into the array (400) may be selectively altered, thus modifying the magnification or zoom of the image detected by the cameras. FIG. 4A shows an illustrative configuration with a wide field of view (419). FIG. 4B shows an illustrative configuration with a more narrow field of view (419). Accordingly, images received by the cameras through the configuration of FIG. 4B may be of a higher magnification than those received through the configuration of FIG. 4A.

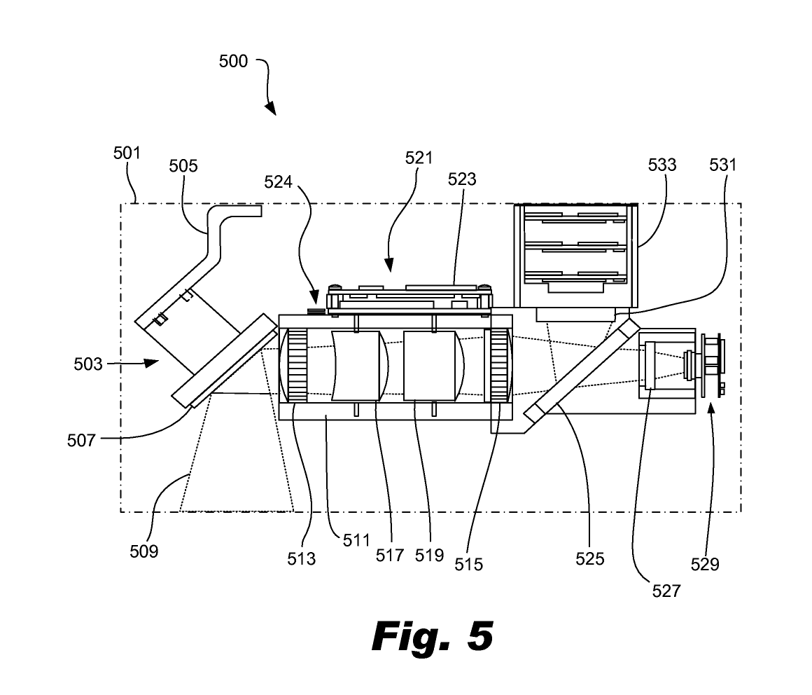

Referring now to FIG. 5, an illustrative system (500) for optical sensing in an aerial vehicle is shown with components in an illustrative placement within a chassis (501). A fast steering mirror (503) may be anchored to at least one wall of the chassis (501) with a bracket (505) such that the mirror surface (507) is at a desired default angle and permits entering light (509) to be reflected from the mirror surface (507) into a lens array housing (511).

The lens array housing (511) may include passive lenses (513, 515) and adaptive polymer lenses (517, 519). A controller board (521) may house integrated circuits (523) configured to implement the mirror control module (103, FIG. 1), the lens control module (107, FIG. 1), and the communication module (113) described above. MEMS gyroscopes (524) may provide tilt feedback to the controller board (521). A dichroic beam splitter (525) may be disposed at an angle from the output of the lens array housing (511) and transmit SWIR light through a compensation lens (527) to an SWIR camera (529) while reflecting visible and NIR light through a compensation lens (531) to a VIS/NIR camera (533).

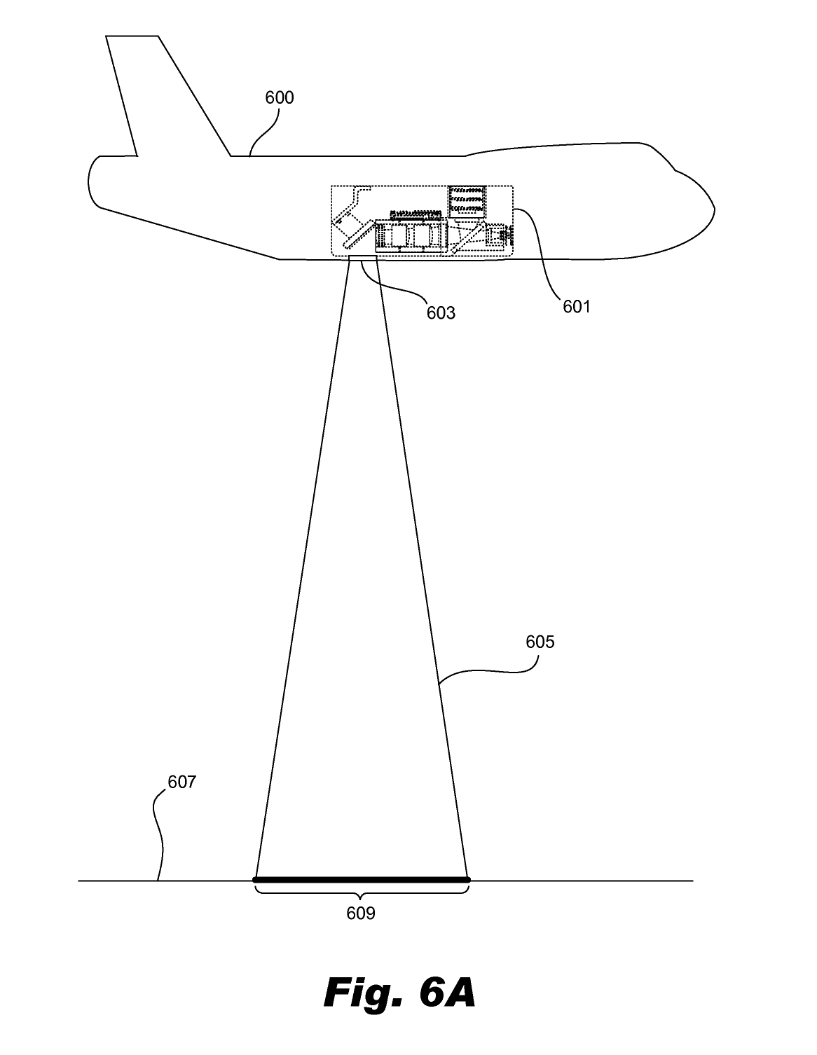

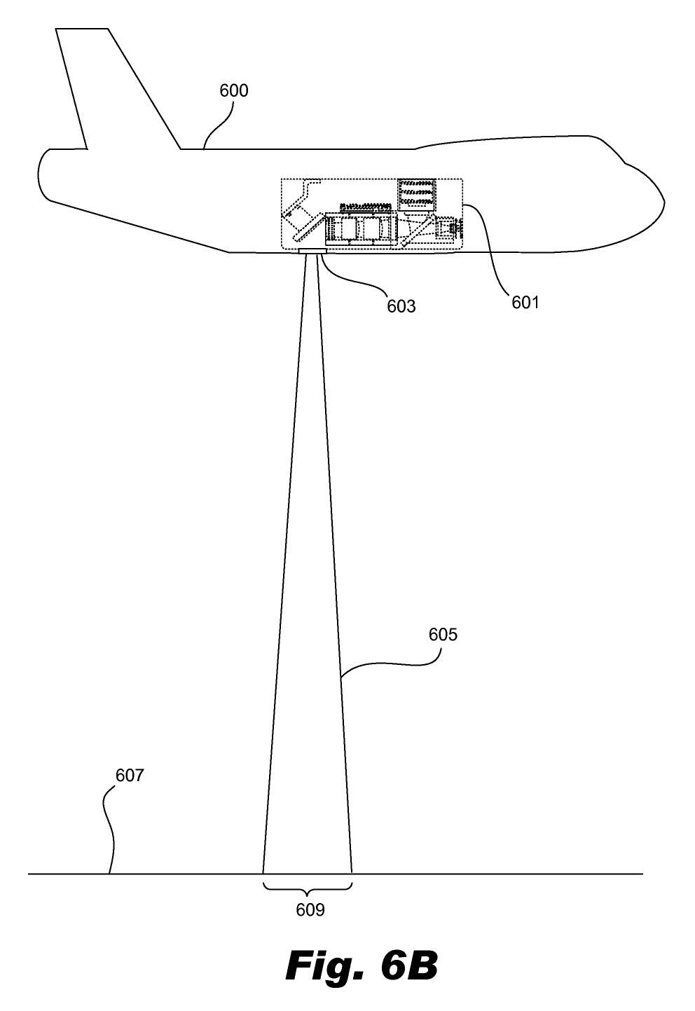

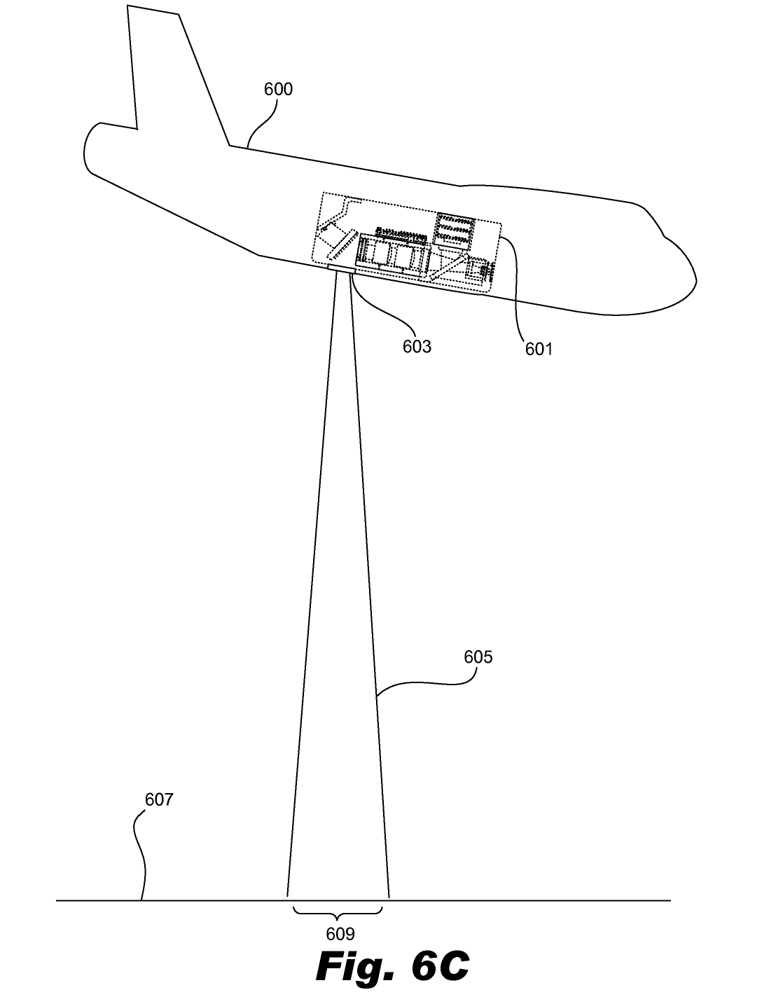

Referring now to FIGS. 6A-6C, an illustrative aerial vehicle (600) is shown housing an illustrative optical system (601) according to the principles described herein. The aerial vehicle (600) may include a window (603) through which optical energy (605) reflected from the ground or structures, people or other objects on the ground (607) is received into the system (601). The field of view (609) captured by the cameras in the system (601) is also shown.

As shown in FIGS. 6A and 6B, the field of view (609) may be selectively altered according to a desired level of magnification. This may be done by a lens control module (107, FIG. 1) selectively driving adaptive polymer lenses (517, 519, FIG. 5) to the desired magnification level in accordance with an algorithm or data received from a remote user or control system as explained herein.

As shown in FIG. 6C, the field of view (609) below the aerial vehicle (600) may remain substantially stable despite changes in pitch or elevation by the aerial vehicle (600). The stability may be achieved by using gyroscopic feedback to produce a compensatory movement in a fast steering mirror (503, FIG. 5) in accordance with principles described herein.

### Illustrative Methods

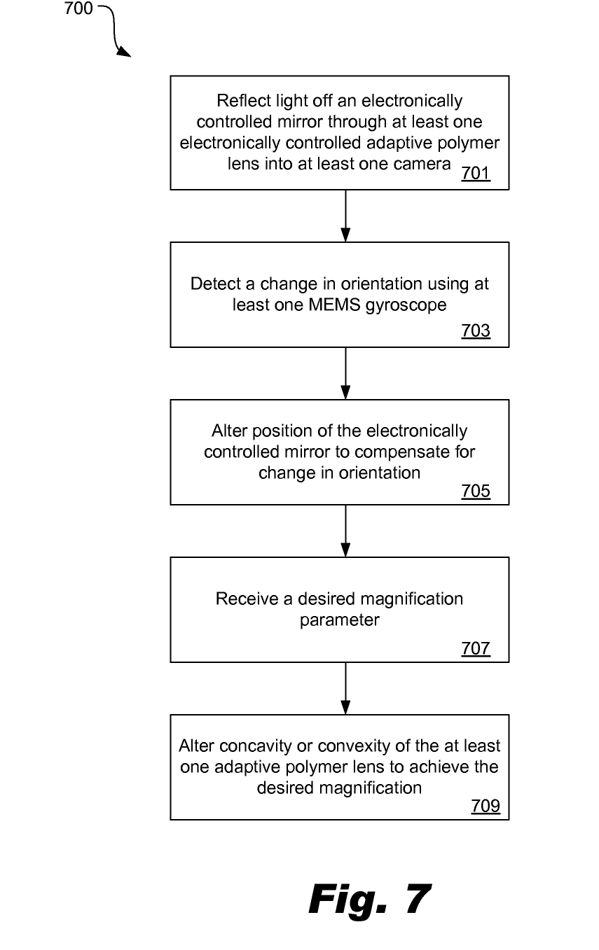

Referring now to FIG. 7, a flowchart of an illustrative method (700) of optical sensing in an aerial vehicle is shown. The method (700) may include receiving light from a region of interest and reflecting (step 701) that light with an electronically-controlled mirror through at least one electronically-controlled adaptive polymer lens into at least one camera in an aerial vehicle.

The method (700) may also include detecting (step 703) a change in orientation in at least one MEMS gyroscope and altering (step 705) a position of the electronically-controlled mirror to compensate for the change in orientation.

Additionally, the method (700) may include receiving (step 707) a desired magnification parameter for the region of interest and altering (step 709) a concavity or convexity of the at least one adaptive polymer lens to achieve the desired magnification.

In certain embodiments, the steps of detecting (step 703) a change in orientation, altering (step 705) the position of the mirror, receiving (step 707) a desired magnification parameter, and altering (step 709) a concavity or convexity of the adaptive polymer lens(es) may be performed in any order that may best suit a particular application. Moreover, in certain embodiments one or more of these steps may be omitted.

The preceding description has been presented only to illustrate and describe exemplary embodiments of the present system and method. It is not intended to be exhaustive or to limit the present system and method to any precise form disclosed. Many modifications and variations are possible in light of the above teaching. It is intended that the scope of the present system and method be defined by the following claims.

What is claimed is:

1. A system for optical sensing in an aerial vehicle, comprising:
at least one camera;
an electronically-controlled mirror configured to dynamically direct light from a region of interest into said at least one camera; and
at least one electronically-controlled adaptive lens disposed between said mirror and said camera.

2. The system of claim 1, further comprising:
at least one microelectromechanical system (MEMS) gyroscope configured to detect a change in orientation along at least one axis of said system; and
a mirror control module in communication with said at least one gyroscope and said mirror;
wherein said mirror control module is configured to provide control signals configured to compensate for said change in orientation by repositioning said electronically-controlled mirror.

3. The system of claim 2, wherein said electronically-controlled mirror comprises at least one of a piezoelectric device and an acoustic coil configured to change an orientation of said mirror according to control signals received from said mirror control module.

4. The system of claim 1, further comprising a lens control module configured to alter a focus of said at least one electronically-controlled adaptive lens in accordance with a desired magnification parameter.

5. The system of claim 4, further comprising a communication module configured to receive said desired magnification parameter from an external source and transmit said desired magnification parameter to said lens control module.

6. The system of claim 5, wherein said communication module is communicatively coupled to said at least one camera and further configured to transmit images received from said camera to an external device.

7. The system of claim 1, further comprising at least one fixed-power lens disposed between said camera and said mirror.

8. The system of claim 1, wherein said at least one camera comprises a first camera configured to detect visible and near-infrared (NIR) wavelengths of light and a second camera configured to detect short-wave infrared (SWIR) wavelengths of light.

9. An aerial vehicle, comprising:
a main body comprising at least one window;
at least one camera disposed within said main body;
an electronically-controlled mirror configured to dynamically direct light received through said window into said at least one camera; and
at least one electronically-controlled adaptive polymer lens disposed between said mirror and said camera.

10. The aerial vehicle of claim 9, wherein said vehicle is unmanned.

11. The aerial vehicle of claim 9, further comprising:
at least one microelectromechanical system (MEMS) gyroscope configured to detect a change in orientation along at least one axis of said system; and
a mirror control module in communication with said at least one gyroscope and said mirror;
wherein said mirror control module is configured to provide control signals configured to compensate for said change in orientation by repositioning said electronically-controlled mirror.

12. The aerial vehicle of claim 11, wherein said electronically-controlled mirror comprises at least one of a piezoelectric device and an acoustic coil configured to change an orientation of said mirror according to control signals received from said mirror control module.

13. The aerial vehicle of claim 9, further comprising a lens control module configured to alter a focus of said at least one electronically-controlled adaptive polymer lens in accordance with a desired magnification parameter.

14. The aerial vehicle of claim 13, further comprising a communication module configured to receive said desired magnification parameter from an external source and transmit said desired magnification parameter to said lens control module.

15. The aerial vehicle of claim 14, wherein said communication module is communicatively coupled to said at least one camera, and further configured to transmit images received from said camera to an external device.

16. The aerial vehicle of claim 9, further comprising at least one fixed-power lens disposed between said camera and said mirror.

17. The aerial vehicle of claim 9, wherein said at least one camera comprises a first camera configured to detect visible and near-infrared (NIR) wavelengths of light and a second camera configured to detect short-wave infrared (SWIR) wavelengths of light.

18. A method comprising reflecting light from a region of interest with an electronically-controlled mirror so that said light is directed through at least one electronically-controlled adaptive polymer lens into at least one camera in an aerial vehicle.

19. The method of claim 18, further comprising:
detecting a change in orientation in at least one microelectromechanical system (MEMS) gyroscope; and
altering a position of said electronically-controlled mirror to compensate for said change in orientation.

20. The method of claim 18, further comprising altering a concavity or convexity of said at least one electronically-controlled adaptive polymer lens in accordance with a desired magnification parameter.
